(19) United States
(12) Patent Application Publication
(10) Pub. No.: US 2026/0017484 A1
(43) Pub. Date: Jan. 15, 2026

(54) METHOD AND DEVICE FOR GENERATING A PROJECT-SPECIFIC NETWORK ARCHITECTURE

(71) Applicant: Robert Bosch GmbH, Stuttgart (DE)

(72) Inventors: Jens Eric Markus Mehnert, Malmsheim (DE); Nico Johannes Maldener, Tamm (DE); Simon Kast-Fuchs, Leonberg (DE)

(21) Appl. No.: 19/262,526

(22) Filed: Jul. 8, 2025

(30) Foreign Application Priority Data
Jul. 10, 2024 (DE) 10 2024 206 526.9

(51) Int. Cl. G06N 3/04

(52) U.S. Cl. CPC G06N 3/04

(57) ABSTRACT

A method for generating a project-specific network architecture. The method includes: providing a foundation model, in particular a large language model, with a LoRa network adaptation; providing a model library which comprises training data pairs, wherein the training data pairs in each case include input data that comprise model application and/or model and/or hardware and/or software specifications, and output data that include at least one network architecture associated with the respective input data; selecting a project-specific training pair based on the model library; and training the LoRa network of the foundation model for generating the project-specific network architecture on the basis of the project-specific training pair.

### FIELD

The present invention relates to a method and a device for generating a project-specific network architecture.

### BACKGROUND INFORMATION

In the (serial) development of neural networks, scaling represents one of the greatest challenges. In particular, the scaling laws for neural networks, which are the subject of empirical research, play a role here. While scaling up networks, as illustrated by the current development of large language models, appears comparatively simpler, scaling down to a production-ready target hardware involves much more complex problems.

The upscaling of neural networks has made considerable progress in recent years. By enlarging the models, a significant improvement in generalization ability is achieved, which increases the performance and range of applications of these machine learning models. This development is particularly illustrated by examples such as ChatGPT, which achieves high accuracy and flexibility in language processing due to its enormous size and complexity.

The limitations of upscaling are primarily defined by the availability and performance of the training and inference hardware, as well as by the quantity and quality of the available (training) data. As long as these resources are available in sufficient quantities, there seem to be few restrictions on the growth and improvement of the models.

In contrast, scaling down neural networks to serial production-ready target hardware is significantly more complex. Different network architectures behave differently on different hardware, which makes hardware-independent development of such neural networks almost impossible. A trivial solution is to develop hardware and network architecture together in order to ensure optimal coordination. Alternatively, a model library with different architectures could be created, from which the most efficient architecture is then selected based on the available hardware.

The co-development of hardware and software represents a promising, albeit complex, solution in order to maximize the efficiency and performance of neural networks. A modular approach, where a variety of architectures are provided for different hardware requirements, may also be practical. This strategy makes a flexible adaptation and optimal use of existing hardware possible by selecting the most efficiently operating architecture.

### SUMMARY

In light of the above, it is an object of the present invention to specify a further improved method and/or a corresponding device.

The object may be achieved by a method according to certain features of the present invention.

### SUMMARY

According to a first aspect of the present invention, a method for generating a project-specific network architecture is provided. According to an example embodiment of the present invention, the method comprises the following steps”
providing a foundation model, in particular a large language model, with a LoRa network adaptation;
providing a model library which comprises training data pairs, wherein the training data pairs in each case consist of input data that comprise model application and/or model and/or hardware and/or software specifications, and output data that comprise at least one network architecture associated with the respective input data;
selecting a project-specific training pair based on the model library; and
training the LoRa network of the foundation model for generating the project-specific network architecture on the basis of the project-specific training pair.

It is understood that the steps according to the present invention, as well as other optional steps, do not necessarily have to be executed in the order shown, but can also be executed in a different order. Other intermediate steps can also be provided. The individual steps can also comprise one or more sub-steps without departing from the scope of the method according to the present invention.

According to a second aspect of the present invention, a device for generating a project-specific network architecture is provided. According to an example embodiment of the present invention, the device comprises an evaluation and computing unit which is designed to execute the following steps:
providing a foundation model, in particular a large language model, with a LoRa network adaptation;
providing a model library which comprises training data pairs, wherein the training data pairs in each case consist of input data that comprise model application and/or model and/or hardware and/or software specifications, and output data that comprise at least one network architecture associated with the respective input data;
selecting a project-specific training pair based on the model library; and
training the LoRa network of the foundation model for generating the project-specific network architecture on the basis of the project-specific training pair.

The explanations given for the method of the present invention apply accordingly to the device of the present invention. It is understood that linguistic modifications of features formulated for the method can be reformulated for the device in accordance with standard linguistic practice, without such formulations having to be explicitly listed here.

The present invention makes it possible to train a dynamic model library with a foundation model as a basis. The foundation model can also have a LoRa adaptation. The present method makes it possible to generate network architectures with predetermined specifications for a given hardware more easily and quickly. This is made possible by the adapted foundation model. The adapted foundation model therefore preferably represents a generator for network models that match predetermined hardware specifications.

The present method has several advantages. On the one hand, it is possible to generate (first) network architectures without a long development time. Network architectures generated in this way can then serve as a basis for manual further development and/or further network architecture searches. Furthermore, it is possible to generate networks even for previously unknown hardware by providing the new hardware specifications. The present method provides decision-making assistance for the design of hardware on which a neural network with a hardware-optimized network architecture is to be executed. Furthermore, the present method can preferably automatically optimize a model library by means of self-supervised learning. Furthermore, new models and/or new model types and/or network architectures can be added cost-effectively by means of the present method, in particular based on the LoRa technology.

Particularly preferably, a neural network that comprises the generated or further optimized, project-specific network architecture is trained on the basis of training data, which can be selected depending on the project or the task to be fulfilled by the neural network, for the project-specific application case, for example classifying and/or segmenting objects in image data.

In the present case, for generating the project-specific network architecture, according to an example embodiment of the present invention, a foundation model that is set up to generate code is used as a starting point. The foundation model can be, for example, a large language model (LLM), such as ChatGPT or the like. Furthermore, in the present case, a model library of already known network architectures with associated data specifications is preferably used as a starting point. This takes advantage of the fact that the accumulated knowledge of large language models (LLMs) includes model descriptions of known and already implemented neural networks. It is known what the neural networks are used for (tasks), on which hardware they are operated (hardware specifications), how good the results are (performance), etc. In the present case, all of this known information-specific to the problem, input data, quality, hardware, and/or other factors-is preferably used as respective input data for the foundation model during training. As already known output data, which in each case correspond to a labeled output datum, the foundation model is furthermore provided with the already known and often precisely described network architecture of the training. The output data can be provided, for example, by Pytorch code that describes the network architecture.

In an initial training step of the foundation model, training pairs of the form (project-specific network description +possibly further criteria, network architecture) = (prompt, architecture) can be generated from the descriptions of the elements of the model library. Then, on the basis of the training pairs, a LoRa training of the foundation model is performed. The result is preferably a neural network with network architecture generated by the foundation model.

In a further aspect of the present invention, it is provided that the input data and/or the output data be provided as text prompts and/or as statistical descriptions and/or as code descriptions in a programming language.

Since not all input data can be provided as input text or in text format, it is preferable to allow and add a statistical and/or other description of the input data as training input data. The input data can also comprise information about the training data used in each case to train the network architecture used as output data. Preferably, the original training data in the input data can also be used for training the foundation model.

In a further aspect of the present invention, it is provided that the method further comprises: optimizing the generated, project-specific network architecture by prompt engineering, in particular by adapting and/or expanding and/or curating the input data of the selected training pair.

In order to obtain the best possible results for the network architecture, according to an example embodiment of the present invention, it is preferable, in particular after the initial training, to use “prompt engineering” to ascertain which would have been the best model or network description for a neural network with the generated network architecture (retrospectively). This is possible, for example, via gradient descent. Gradients are preferably defined on the input data rather than on the trainable LoRa weights. Subsequently, with given and fixed network architecture output from the foundation model, the most optimal input (prompt) can be ascertained.

In prompt engineering, a modified training pair (prompt*, architecture) is preferably generated for a plurality of or all training data pairs (prompt, architecture). For this purpose, a network G* is preferably generated, through which the optimal prompts can be found. Then, preferably for a plurality of or all network architectures, a new, manually curated training pair (prompt*, architecture) is generated, wherein it is preferably ensured that the prompt* modified in each case contains no architecture information. Furthermore, additional information that is not present in the (initial) prompt can be added to the modified prompt*. The LoRa adaptation can then be trained again on the basis of the training pairs that are modified in each case. In this way, an optimized or curated network can be obtained.

In a further aspect of the present invention, it is provided that the method further comprises the following steps: optimizing the already optimized, project-specific network architecture by self-supervised learning, in particular by supplementing the input data of the selected training pair with a required network performance criterion.

Subsequently, or after prompt engineering, the network architecture can be further optimized in an additional step through self-supervised learning. Since result metrics of the generated network architectures can preferably also be entered in the prompt or in the input data, it is also possible to require better neural networks. For example, if the neural network was specified with a “Mean Intersection over Union” (mIOU) of 0.6 during training in the (initial) prompt, a higher mIOU can be required in a modified prompt when generating a new network with a new network architecture.

Preferably, according to an example embodiment of the present invention, the neural network is trained with the obtained network architecture optimized by prompt engineering on the basis of training data, and the trained neural network is subsequently evaluated in order to obtain a result for this network in a target metric. On the basis of this, a further modified prompt** can now be generated, in which, for example, target metric value a can be replaced by a better target metric value a*. This can be carried out randomly by requiring a*>a or by means of specifying a maximum value. Afterward, a modified network architecture can be generated through the foundation model using the modified prompt**. This modified network architecture can then be trained and evaluated again. In this way, a modified target metric a** can be obtained.

Such an optimized network can then be retrained for the project-specific application case on the basis of new training data.

In a further aspect of the present invention, it is provide that self-supervised learning is performed until the network performance criterion is fulfilled or another termination criterion is reached.

In a further aspect of the present invention, it is provided that the input data comprise information about hardware specifications, data specifications, task specifications, result specifications, training data used and/or an output format.

Additional information may also be included in the input data.

In a further aspect of the present invention, it is provided that the generated or optimized project-specific network architecture is further optimized by neural architecture search.

In a further aspect of the present invention, a control unit is also provided, According to an example embodiment of the present invention, the control unit is comprised in a vehicle with an autonomous driving function and/or a robotic system and/or an industrial machine, and on which a neural network with a network architecture found according to the method of the present invention in one of its aspects can be implemented and executed. The control unit can be designed as an embedded system. The network architecture can be optimized on the basis of the hardware specifications of the control unit.

In a further aspect of the present invention, a computer program having program code is provided for executing at least parts of the method of the present invention in one of its aspects when the computer program is executed on a computer. In other words, a computer program (product) comprising instructions which, when the program is executed by a computer, cause the computer to execute the method/steps of the method of the present invention in one of its aspects.

In a further aspect of the present invention, a computer-readable data carrier having program code of a computer program is provided for executing at least parts of the present method in one of its aspects when the computer program is executed on a computer. In other words, the present invention relates to a computer-readable (memory) medium comprising instructions which, when executed by a computer, cause the computer to execute the method/steps of the method of the present invention in one of its aspects.

The described example embodiments and developments of the present invention can be combined with one another as desired.

Further possible embodiments, developments and implementations of the present invention also include combinations not explicitly mentioned of features of the present invention described above or in the following relating to the exemplary embodiments.

### BRIEF DESCRIPTION OF THE DRAWINGS

The figures are intended to impart further understanding of the embodiments of the present invention. They illustrate embodiments and, in connection with the description, serve to explain principles and concepts of the present invention.

Other example embodiments of the present invention and many of the mentioned advantages are apparent from the figures. The illustrated elements of the figures are not necessarily shown to scale relative to one another.

### BRIEF DESCRIPTION OF THE DRAWINGS

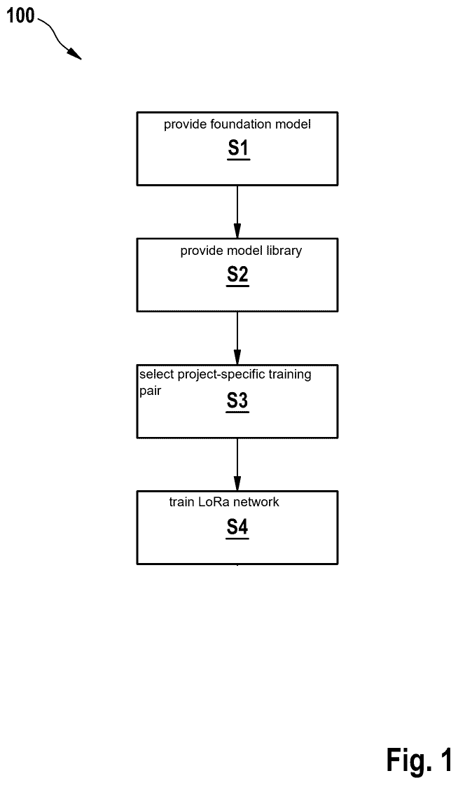

FIG. 1 is a schematic flow chart of an exemplary embodiment of the present method.

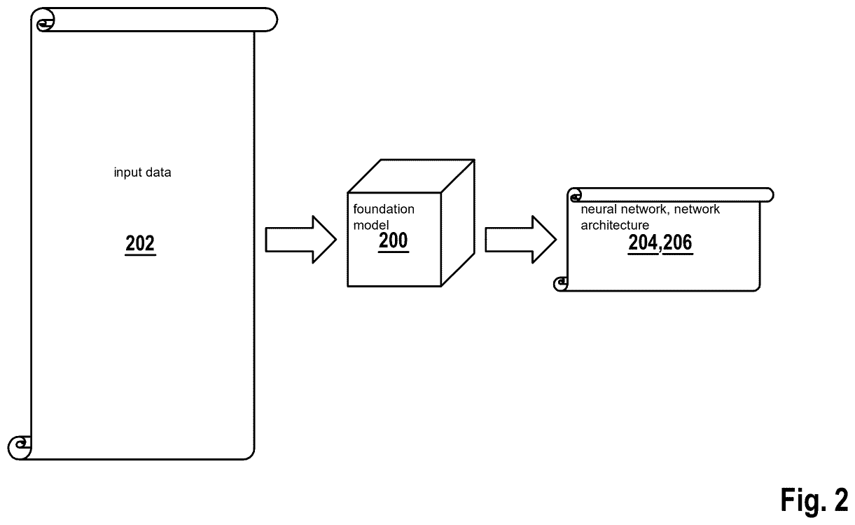

FIG. 2 is a schematic block diagram of a method in the inference case, according to an example embodiment of the present invention.

### DETAILED DESCRIPTION OF EXAMPLE EMBODIMENTS

In the figures, identical reference signs denote identical or functionally identical elements, parts or components, unless stated otherwise.

FIG. 1 is a schematic flow chart of a method for generating a project-specific network architecture.

In any embodiment, the method can be executed, at least in part, by a device 100, which, for this purpose, can comprise a plurality of components not shown in more detail, for example one or more provisioning units and/or at least one evaluation and computing unit. It is self-evident that the provisioning unit can be designed together with the evaluation and computing unit or can be different therefrom. Furthermore, the device 100, which can be part of a system, can comprise a storage unit and/or an output unit and/or a display unit and/or an input unit.

The computer-implemented method comprises at least the following steps:

In a step S1, a foundation model, in particular a large language model, is provided with a LoRa network adaptation.

In a step S2, a model library which comprises training data pairs is provided, wherein the training data pairs in each case consist of input data that comprise model application and/or model and/or hardware and/or software specifications, and output data that comprise at least one network architecture associated with the respective input data.

In a step S3, a project-specific training pair is selected based on the model library.

In a step S4, the LoRa network of the foundation model is trained for generating the project-specific network architecture on the basis of the project-specific training pair.

FIG. 2 shows an inference case of the foundation model 200 trained in the present case for generating a project-specific network architecture. In this case, on the basis of input data 202, which, for example, comprise information about hardware specifications, data specifications, task specifications, result specifications, training data used and/or an output format, a neural network 204 having a network architecture 206 that fulfills the specifications of the input data 202 can be generated by the foundation model 200 with LoRa adaptation.

1-10. (canceled)

11. A method for generating a project-specific network architecture, the method comprising the following steps:
providing a foundation model, the foundation model being a large language model, with a LoRa network adaptation;
providing a model library which includes training data pairs, wherein the training data pairs in each case include: (i) respective input data that include model application and/or model and/or hardware and/or software specifications, and (ii) output data that include at least one network architecture associated with the respective input data;
selecting a project-specific training pair based on the model library; and
training the LoRa network of the foundation model to generate the project-specific network architecture based on the project-specific training pair.

12. The method according to claim 11, wherein the input data and/or the output data are provided as text prompts and/or as statistical descriptions and/or as code descriptions in a programming language.

13. The method according to claim 11, wherein the method further comprises:
optimizing the generated, project-specific network architecture by prompt engineering, by adapting and/or expanding and/or curating the input data of the selected training pair.

14. The method according to claim 13, wherein the method further comprises:
optimizing the optimized, project-specific network architecture by self-supervised learning, by supplementing the input data of the selected training pair with a required network performance criterion.

15. The method according to claim 14, wherein self-supervised learning is performed until the network performance criterion is fulfilled or another termination criterion is reached.

16. The method according to claim 11, wherein the input data include information about hardware specifications, and/or data specifications, and/or task specifications, and/or result specifications, and/or training data used, and/or an output format.

17. The method according to claim 11, wherein the generated project-specific network architecture is optimized by neural architecture search.

18. A non-transitory computer-readable data carrier on which is stored program code of a computer program for generating a project-specific network architecture, the computer program, when executed by a computer, causing the computer to perform the following steps:
providing a foundation model, the foundation model being a large language model, with a LoRa network adaptation;
providing a model library which includes training data pairs, wherein the training data pairs in each case include: (i) respective input data that include model application and/or model and/or hardware and/or software specifications, and (ii) output data that include at least one network architecture associated with the respective input data;
selecting a project-specific training pair based on the model library; and
training the LoRa network of the foundation model to generate the project-specific network architecture based on the project-specific training pair.

19. A device for generating a project-specific network architecture, the device comprising:
an evaluation and computing unit configured to execute the following steps:
providing a foundation model, including a large language model, with a LoRa network adaptation;
providing a model library which includes training data pairs, wherein the training data pairs in each case include: (i) respective input data that include model application and/or model and/or hardware and/or software specifications, and (ii) output data that include at least one network architecture associated with the respective input data;
selecting a project-specific training pair based on the model library; and
training the LoRa network of the foundation model to generate the project-specific network architecture based on the project-specific training pair.
